(19) United States
(12) Patent Application Publication
(10) Pub. No.: US 2015/0106162 A1
(43) Pub. Date: Apr. 16, 2015

(54) SURVEY SYSTEM AND METHOD

(71) Applicant: Research Metrics, LLC, Toledo, OH (US)

(72) Inventors: Robert A. Bleile, Perrysburg, OH (US); Emil Tsankov, Varna (BG)

(21) Appl. No.: 14/513,675

(22) Filed: Oct. 14, 2014

Related U.S. Application Data
(60) Provisional application No. 61/890,506, filed on Oct. 14, 2013.

(51) Int. Cl. G06Q 30/02

(52) U.S. Cl. CPC G06Q 30/0203
USPC 705/7.32

(57) ABSTRACT

A survey application includes a recording module configured to synchronously capture ancillary data associated with an entry of survey data, wherein the entry of the survey data may be reviewed to determine an authenticity of the survey application. The survey application may include a playback application for receiving the captured ancillary data and for displaying a representation of the ancillary data associated with an entry of survey data.

### CROSS-REFERENCE TO RELATED APPLICATION

This application claims the benefit of U.S. Provisional Patent Application Ser. No. 61/890,586 filed Oct. 14, 2013, the entire disclosure of which is hereby incorporated herein by reference.

### FIELD OF THE INVENTION

The invention relates to a survey system and method, and more particularly, to a survey system and method which includes a feature to determine survey authenticity, effectiveness, and validity.

### BACKGROUND OF THE INVENTION

Surveys are frequently used to obtain information from respondents regarding various topics. For example, surveys have historically been used to gather information regarding respondents' interests, motivations, perceptions, preferences, habits, and the like. Surveys have been delivered in many forms including by oral and written questions. Surveys may be conducted as part of non-specific market research, and in some instances, may be conducted after a respondent has vacated a store, website, location, or other venue in which an experience of the respondent is desired to be known. Responses to the survey questions can be analyzed and used to obtain statistical information about a group of respondents, which can be further extrapolated to a larger population.

Commonly owned U.S. Pat. Appl. Pub. No. 20130046737, incorporated herein by reference in its entirety, describes, in one aspect, a survey system that utilizes a mobile computing device having a user interface to generate display data in the form of a survey having questions pertaining to interests, motivations, perceptions, preferences, habits, and the like, and requesting inputs in response thereto. The inputs of each survey completed by a respondent are stored as an individual entry of survey data in the memory of the mobile computing device, and may be further transmitted to a management server for storage in a survey database. The stored survey data may be retrieved from the management server and may be analyzed by a survey data validation module to locate fraudulent or duplicate entries of the encoded survey data and to determine a probability of authenticity of the encoded survey data. However, efforts to prevent fraudulent or duplicate entries in response to surveys are not able to determine whether a given survey is authentic. Moreover, it is not possible to determine whether the respondent has devoted adequate attention to the survey, or to be able to determine what the respondent is actually doing during execution of the survey.

Therefore, it would be desirable to develop a survey system and method that includes a way to determine the effectiveness and validity of a survey.

### SUMMARY OF THE INVENTION

In concordance and agreement with the present invention, a survey system and method which includes a feature to determine survey effectiveness and validity has surprisingly been discovered.

In one embodiment, the survey application comprises: a recording module configured to synchronously capture ancillary data associated with an entry of survey data, wherein the entry of the survey data may be reviewed to determine an authenticity of the survey application.

In another embodiment, the survey application comprises: a recording module configured to synchronously capture ancillary data associated with an entry of survey data, and a playback application for receiving the captured ancillary data and for displaying a representation of the ancillary data associated with an entry of survey data.

In another embodiment, the survey system comprises: a computing device including a recording application configured to synchronously capture and encode ancillary data associated with an entry of survey data; and a playback application for receiving the encoded ancillary data, wherein the playback application is configured to virtually recreate at least a portion of the entry of the survey data to enable an analysis of the entry of the survey data.

The invention also provides a survey method which comprises the steps of: providing a user with a survey requiring an entry of survey data; synchronously recording ancillary data associated with the entry of survey data; recreating virtually at least a portion of the entry of the survey data from the recorded ancillary data; and analyzing the entry of the survey data to determine an effectiveness of the survey.

### DESCRIPTION OF THE DRAWINGS

The above, as well as other advantages of the present invention, will become readily apparent to those skilled in the art from the following detailed description of a preferred embodiment when considered in the light of the accompanying drawings, in which:

FIG. 1 is a graphical representation of a survey system according to an embodiment of the present invention;

FIG. 2 is a schematic block diagram of the survey system according to an embodiment of the present invention; and

FIG. 3 is an exemplary graphical representation of a playback system according to an embodiment of the present invention.

### DESCRIPTION OF THE PREFERRED EMBODIMENTS

The following detailed description and appended drawing describe and illustrate an exemplary embodiment of the invention. The description and drawing serve to enable one skilled in the art to make and use the invention, and are not intended to limit the scope of the invention in any manner. In respect of the method disclosed, the order of the steps presented is exemplary in nature, and thus, is not necessary or critical.

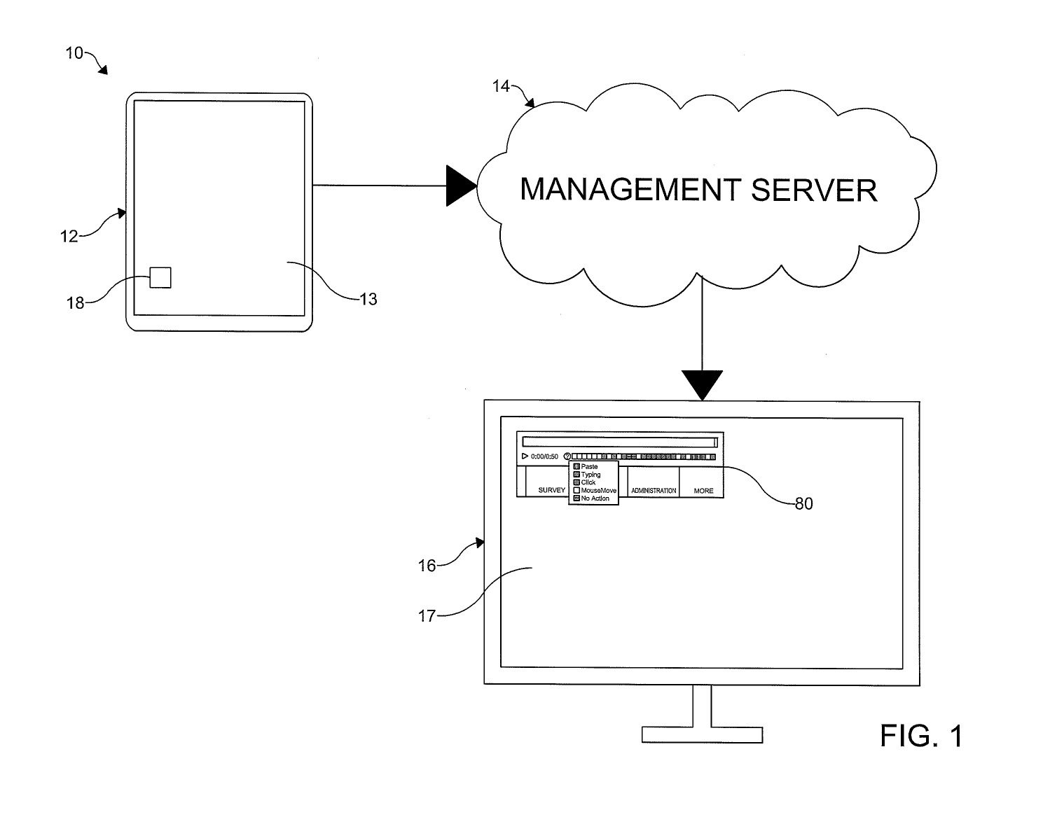

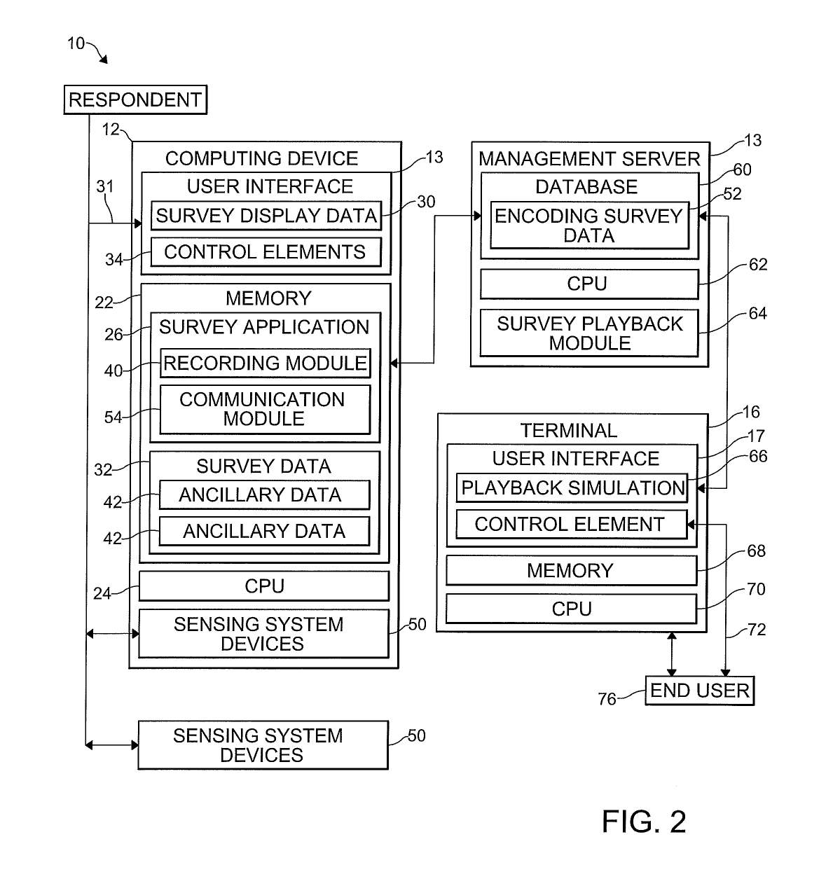

FIGS. 1 and 2 show a survey system 10 according to an embodiment of the present invention. As shown, the system 10 includes a computing device 12 having a user interface 13, a management server 14, and a terminal 16 having a second user interface 17. The survey system 10 may also include a survey preparation server (not shown) as a separate component or integrated into the computing device 12 or the management server 14, if desired. It is understood that the system 10 may include other additional components necessary for operation of the system 10.

The computing device 12 is any device suitable to collect survey data including, but not limited to those which are categorized by the generic, technological terms of Smartphone, personal computing tablet, personal lap-top computer, desktop computer and personal notebook computer. Examples of such computing devices 12 are the APPLE IPHONE, APPLE IPAD, BLACKBERRY PLAYBOOK, BLACKBERRY TABLET, SAMSUNG GALAXY TAB, MOTOROLA DROID, HTC ANDROID, and numerous others sold by APPLE, HTC, MOTOROLA, DELL, SAMSUNG, HP, SANYO, BLACKBERRY, TOSHIBA, ACER, LENOVO, ASUS, and the like.

As best seen in FIG. 2, the computing device 12 includes memory 22 and a processor or CPU 24. The memory 22 may be a single storage device or may be multiple storage devices. Portions of the memory 22 may also be located on the processor 24. Furthermore, the memory 22 may be a solid state storage system, a magnetic storage system, an optical storage system, or any other suitable storage system. In certain embodiments, the memory 22 is configured to store a survey program or application 26. Other data may be stored in the memory 22 as described hereinafter.

The processor 24 is configured to retrieve from the memory 22 and execute the survey application 26 on the computing device 12. It is understood that the configuration and functions of the processor 24 may be adjusted in real-time or pre-programmed by the original equipment manufacturer (OEM) or user. It is further understood that the functions of the processor 24 may have stored settings that may be recalled and processed, as desired. The survey application 26 includes processor executable instructions for configuring the processor 24 to perform a variety of tasks. In certain embodiments, the survey application 26 configures the processor 24 to generate survey display data 30 in the form of a survey having questions pertaining to interests, motivations, perceptions, preferences, habits, and the like, and requesting inputs 31 in response thereto. The inputs 31 of each survey 30 completed by a respondent are stored as an individual entry of survey data 32 in the memory 22 of the computing device 12. The inputs 31 can be entered by any means as desired such as by an inputting device (e.g. a finger, a stylus, etc.) or a control element 34 displayed or disposed in the user interface 13, for example.

The survey application 26 includes a recording module 40. The recording module 40 simultaneously generates or collects a plurality of ancillary data 42 associated with actions of the respondent as the respondent completes the survey 30 on the computing device 12. Accordingly, each ancillary data 42 is associated with the individual entry of survey data 32 created for the completed survey 30. Accordingly, the ancillary data 42 associated with the actions of the respondent is associated with the individual entry of survey data 32 created for the completed survey 30. The ancillary data 42 associated with actions of the respondent as the respondent completes the survey 30 is synchronously collected by the recording module 40 as the ancillary data 42 is simultaneously generated as the respondent completes the survey 30, beginning at any point before, during and after the survey.

The ancillary data 42 associated with action of the respondent include, but are not limited to, actions taken by the respondent within the survey application, such as movements between questions, as in “next slide/question” or “previous slide/question”; movement between answer options; page scrolls; jump scrolls; orientation and size/scale changes; respondent touch actions; device orientation (e.g. Euler angles and Tait-Bryan angles); text input and selection edit and/or changes; actions made to attachments, as in “attach” and/or “delete” and/or “paste” operations; elapsed time (e.g. a chronological data registry at a start and a completion of the survey to an n^{th} of a second based upon Greenwich Mean Time of a twenty-four (24) hour day); a date; user inactivity to detect if the respondent is using another application or if the respondent is not devoting sufficient attention to the survey; human-machine interface characteristics (e.g. a contact location of an inputting instrument such as a finger, a stylus, etc.) on the user interface 13, a velocity the inputting instrument during contact with the user interface 13, a duration of contact of the inputting instrument with the user interface 13, a style of contact of the inputting instrument with the user interface 13, and a contact pressure of an inputting instrument on the user interface 13).

The ancillary data 42 may be synchronously encoded upon entry of the survey data 32, or may be collected separately from the survey data 32 and be associated therewith. It is further understood that the sensing systems and devices can be internal or external to the computing device 12 such as disposed within the computing device 12, disposed in an accessory to the computing device 12 (e.g. a protective case), or in electrical communication with the computing device 12 (e.g. a wired connection through an input port of the computing device 12, a wireless connection, or a Bluetooth enabled connection), for example.

It is understood that the ancillary data 42 can be collected and/or generated using control elements 34, by the survey application 26 itself, or by use of various external sensing systems and devices 50 such as a vibration, a rotation, and/or a motion sensor (e.g. an accelerometer, a gyroscope, etc.), and a microphone, for example. It is further understood that the sensing systems and devices 50 can be internal or external to the computing device 12 such as disposed within the computing device 12, disposed in an accessory to the computing device 12 (e.g. a protective case), or in electrical communication with the computing device 12 (e.g. a wired connection through an input/output port (I/O port) (not shown) of the computing device 12 (e.g. a universal serial bus (USB)), a wireless connection (e.g., a Wi-Fi® communication, a near field communication, and a Bluetooth® communication), for example.

The survey application 26 may also include a communication module 54 which transmits an encoded survey data 52, including the ancillary data 42, to the management server 14. Transmission of the encoded survey data 52 to the management server 14 can be initiated by the surveyor, the respondent, or any other authorized personnel, as desired, and at any time as desired such as instantaneously before, during, or after completion of the survey 30, at regular predetermined times and/or dates, or when the memory 22 of the computing device 12 has reached a predetermined level, for example.

The management server 14 registers and stores the encoded survey data 52 in a database 60. The database 60 may be any storage device for storing data. The database 60 is configured to communicate with the computing device 12 to send and receive data such as the encoded survey data 52, for example. The database 60 is also in communication with the terminal 16, wherein a command signal received from the user interface 17 of the terminal 16 controls at least one of a storing, a retrieving, and an organizing of the encoded survey data 52 stored in the database 60. In the embodiment shown, the database 60 is disposed in the management server 14. However, the database 60 may be disposed in a remote location and connected to the management server 14 and the terminal 16 via the Internet or other suitable communication means. It is understood that the database 60 may be associated with any computing device 12 and may store any data. It is further understood that the encoded survey data 52 stored in the database 60 may be populated by a plurality of computing devices 12 in various locations.

The stored encoded survey data 52 is retrieved from the database 60 by a central processing unit (CPU) 62 of the management server 14 and is processed. A survey data playback module 64 of the management server 14 may be used to analyze the encoded survey data 52. The survey playback module 64 is configured to virtually recreate at least a portion of the entry of survey data 52 to enable an analysis of the entry of survey data. Using the ancillary data, the entry of survey data may be reviewed for fraudulent and duplicate survey data, for survey effectiveness, for survey authenticity, for survey validity, for evaluating the respondent's interaction with the survey, or the like. In this way, the entry of the survey data may be reviewed to ensure an integrity and an authenticity of the survey data collected, thereby militating against fraudulent and duplicate survey data.

In a non-limiting example, the survey data playback module 64 analyzes the inputs 31 and the ancillary data 42 from one individual entry 32 to determine a probability of authenticity thereof. In another non-limiting example, the survey data playback module 64 analyzes the encoded survey data 52 by identifying the user, date, time, length of time to enter the survey data, the number times during the session the user has executed “paste” commands, and the like.

In addition to being analyzed for survey data validation purposes, it is understood that the ancillary data 42 can also be processed by the management server 14 for remote analysis. In certain embodiment, the CPU 62 prepares the ancillary data 42 of the encoded survey data 52 and generates a playback simulation 66. The playback simulation 66 of the management server 14 may be assembled as visible data such as HTML data, for example, and presented to an end user through the user interface 17 of the terminal 16. The playback simulation 66 allows for analysis of the encoded ancillary data 42 to locate fraudulent or duplicate entries of survey data and determine a probability of validity and authenticity of the survey data. In addition to being analyzed for survey data validation purposes, it is understood that the ancillary data 42 may also be processed by the management server 14 for statistical analysis. The playback simulation 66 may also be used to determine whether a survey respondent devoted adequate attention, time and effort in completing the survey. The playback simulation 66 is therefore a tool useful for determining an effectiveness, authenticity and validity of a survey. As non-limiting examples, the playback simulation 66 may be used to investigate potentially fraudulent respondents, to analyze the respondents' behavior, to improve the respondents' experience based on behavior analysis, to improve the authenticity of the submitted information, and to improve the survey user interface, duration, questions, and the like.

The terminal 16 is any device suitable to display information including, but not limited to those which are categorized by the generic, technological terms of Smartphone, portable consumer electronic device, personal computing device or tablet, personal lap-top or desktop computer, and personal notebook computer. Examples of such terminals 16 are the Apple iPhone, Apple iPad, Blackberry Playbook, Blackberry Tablet, Samsung Galaxy Tab, Motorola Droid, HTC Android, and numerous others sold by Apple, HTC, Motorola, Dell, Samsung, HP, Sanyo, Blackberry, Toshiba, Acer, Lenovo, Asus, and the like. As illustrated, the terminal 16 includes a memory 68 and a processor 70. The memory 68 may be a single storage device or may be multiple storage devices. Portions of the memory 68 may also be located on the processor 70. Furthermore, the memory 68 may be a solid state storage system, a magnetic storage system, an optical storage system, or any other suitable storage system. In certain embodiments, the memory 68 is configured to store personalized information of the end user such as login or username and password, display settings and preferences, for example. Other data may be stored in the memory 68 as desired.

The processor 70 is configured to retrieve the playback simulation 66 of the survey data 30 from the management server 14. It is understood that the configuration and functions of the processor 70 may be adjusted in real-time or pre-programmed by the original equipment manufacturer (OEM) or user. It is further understood that the functions of the processor 70 may have stored settings that may be recalled and processed, as desired. In certain embodiments, the processor 70 of the terminal 16 is configured to receive inputs 72 via the user interface 17. The inputs 72 can be entered by any means as desired such as by an inputting device (e.g. a finger, a stylus, etc.) or a control element 74 displayed or disposed in the user interface 17, for example.

In operation, a surveyor or the respondent activates the survey application 26 of the computing device 12. Upon activation, the survey is displayed on the user interface 13 of the computing device 12. The respondent then operates the computing device 12 and uses the inputting instrument to input responses to the survey into the user interface 13. Simultaneously, the recording module 40 generates and/or synchronously collects the ancillary data 42 associated with the survey being completed by the respondent. After completion of the survey, the inputted responses are stored in the memory 22 of the computing device 12 as an individual entry of encoded survey data 52. The ancillary data 42 may be encoded with the individual entry of survey data, or may be separately encoded as recorded ancillary data. The encoded survey data 52, including ancillary data 42, is then transmitted by the computing device 12 to the management server 14.

Upon receipt of the encoded survey data 52, including the ancillary data 42, from the computing device 12, the management server 14 registers and stores the encoded survey data 52 in a database. The stored encoded survey data 52 is read out by a central processing unit 62 of the management server 14 and is rendered, visualized or otherwise depicted as desired through the survey playback module 64. The survey playback module 64 may be located on the management server 14 or may be remotely located with access to the ancillary data. The playback module 64 allows for analysis of the encoded ancillary data to locate fraudulent or duplicate entries of survey data and determine a probability of validity and authenticity of the survey data. The playback module 64 may also be used to determine whether a survey respondent devoted adequate attention, time and effort in completing the survey. The playback module 64 is therefore a tool useful for determining an effectiveness, authenticity and validity of a survey. As non-limiting examples, the playback module 64 may be used to investigate potentially fraudulent respondents, to analyze the respondents' behavior, to improve the respondents' experience based on behavior analysis, to improve the authenticity of the submitted information, and to improve the survey user interface, duration, questions, and the like.

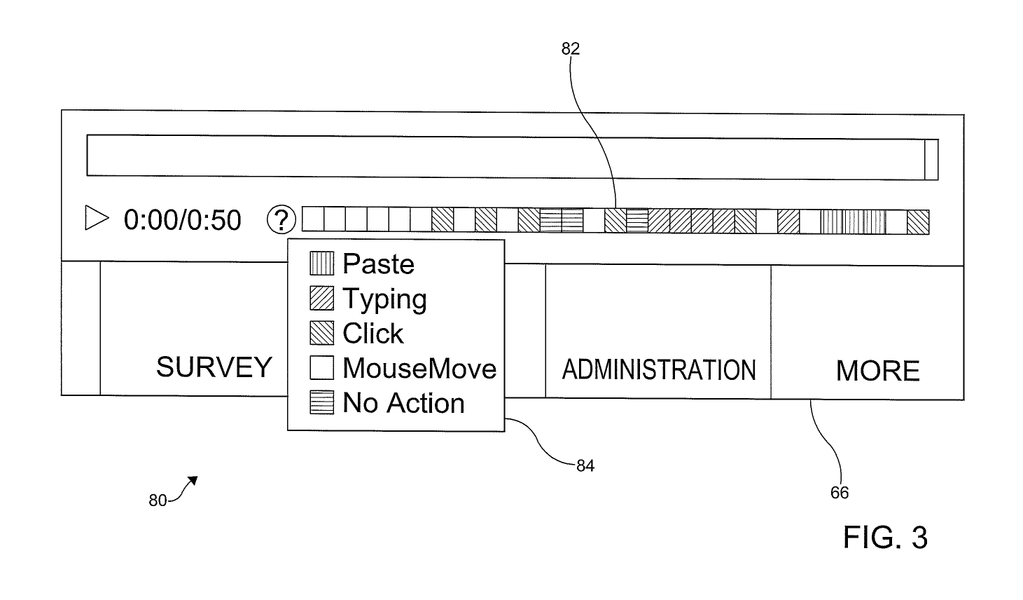

The encoded survey data 52, including the ancillary data 42, may also be transmitted to the terminal 16 for playback by an end user 76 in a playback simulation 66. An exemplary graphical representation 80 of a playback simulation 66 is shown in FIG. 3. The playback simulation 66 may automatically capture and display select ancillary data for a given survey response, such as user identification, date, time, length, number of “paste” commands utilized, or the like. The number of “paste” commands may be of interest because a high number of such commands may be correlated to fraudulent survey completion. In one embodiment, the user actions may include a shading or a color code, including a legend 84, to enhance the speed of replay or to allow for selection or highlighting of certain user actions. As a non-limiting example, a survey response timeline 82 may be provided that provides a timeline of user actions made during the survey response. The survey response timeline 82 may include different colors (shown as different shading areas in FIG. 3) to highlight “paste” commands, typing activity, scrolls, changes, mouse clicks, mouse moves, or times of inactivity. An end user of the playback simulation 66 may therefore be able to quickly review the timeline to determine the effects of various user activities on the survey effectiveness.

Moreover, because the recording module 40 may record all changes made by a user to a survey, the playback simulation 66 may replicate all conditions of the survey at a given point in a playback. Thus, as a non-limiting example, all survey parameters within the playback simulation 66 may be set to exactly the same state as they existed at the moment the synchronous data was captured during the survey response. The survey response may be replayed in virtual time at any point after capture of the synchronous ancillary data. Similarly, the playback simulation 66 may provide visual indicators of user activity during the playback of the survey. As non-limiting examples, the playback application may include labels near an element that is being modified by the survey respondent, so that if at a certain time within the survey response a respondent “pastes” an item, a label indicating a paste may be displayed near the location where the “paste” action occurs. In this way, replay of the recorded synchronous ancillary data 42 in the playback simulation 66 may be enhanced to assist the end user of the playback simulation 66 in interpreting the actions of the survey respondent.

The playback simulation 66 provides a quick and visual way to see what the survey respondents are actually doing during the completion of a survey. The playback simulation 66 provides information regarding who the respondent is, and when and how the respondent completed the survey, in virtual time, as if a reviewer is sitting next to the survey respondent or watching a video of the survey respondent. In addition, a reviewer may receive a color timeline that provides a quick overall impression of the respondent's behavior during the survey response. The reviewer of the playback simulation 66 is able to review the respondent's use of the computing device, including how the respondent moves the mouse cursor, how the respondent enters and edits information (typing, paste, click, change etc.), how long it takes for the respondent to complete the survey, or the like.

As a result of reviewing the playback simulation 66, the survey provider is easily able to investigate potentially fraudulent shoppers or respondents entering potentially inaccurate data, analyze the respondent's behavior, improve the user's experience based on various analyses of the synchronous data, and improve the authenticity of the submitted information. Thus, the overall effectiveness of the survey may be quickly and easily evaluated.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A survey system, comprising:
a recording module configured to capture and store ancillary data associated with an entry of survey data by a respondent using a computing device; and
a user terminal receiving the stored ancillary data and configured to process the ancillary data to display a graphical representation of actions of the respondent during the entry of the survey data for review to determine an authenticity of the survey application.

2. The survey system of claim 1, further comprising a playback application configured to display a representation of the ancillary data associated with the entry of survey data.

3. The survey system of claim 1, wherein the ancillary data is data associated with the actions taken by the respondent as the respondent interacts with the survey system.

4. The survey system of claim 1, further comprising a communication module configured to transmit encoded survey data including the ancillary data to a management server.

5. The survey system of claim 4, wherein the management server further includes a survey playback module configured to virtually recreate at least a portion of the entry of the survey data, including the ancillary data, to enable an analysis of one of the survey data and the entry of the survey data.

6. The survey system of claim 4, wherein the management server generates a playback simulation from the encoded survey data including the ancillary data.

7. The survey system of claim 6, wherein the playback simulation is presented to an end user through a remote user interface.

8. The survey system of claim 7, wherein the playback simulation is configured to capture and to display select ancillary data for a given survey response.

9. The survey system of claim 1, wherein the ancillary data ancillary data is generated using one of control elements of the recording module, a survey application, and external sensing systems and devices.

10. The survey system of claim 1, wherein the ancillary data is synchronously collected by the recording module as the ancillary data is simultaneously generated.

11. A survey system, comprising:
a computing device including a survey application which encodes survey data;
a recording application configured to capture and encode ancillary data associated with an entry of the survey data; and
a management server for receiving the encoded survey data including the encoded ancillary data, the management server including a playback application configured to virtually recreate at least a portion of the entry of the survey data using the ancillary data to enable an analysis of the entry of survey data.

12. The survey system of claim 11, wherein the ancillary data is synchronously collected by the recording module as the ancillary data is simultaneously generated.

13. The survey system of claim 11, further comprising a communication module configured to transmit the encoded survey data including the encoded ancillary data to the management server.

14. The survey system of claim 11, wherein the ancillary data is data associated with actions taken by a respondent within the survey system.

15. The survey system of claim 14, wherein the management server generates a playback simulation from the encoded survey data including the encoded ancillary data.

16. The survey system of claim 15, wherein the playback simulation is presented to an end user through a remote user interface.

17. A survey method, comprising the steps of:
providing a user with a survey requiring an entry of survey data;
recording ancillary data associated with the entry of survey data;
recreating virtually at least a portion of the entry of the survey data from the recorded ancillary data; and
analyzing the entry of the survey data to determine one of an effectiveness, an authenticity, and a validity of the survey data.

18. The survey method of claim 17, wherein the ancillary data is synchronously collected by a recording module as the ancillary data is simultaneously generated.

19. The survey method of claim 17, further including the steps of:
storing the ancillary data and the survey data as encoded survey data, and
transmitting the encoded survey data to a management server.

20. The survey method of claim 19, further including the step of:
generating a playback simulation from the encoded survey data including the ancillary data for presentation to an end user through a remote user interface.
